(19) United States
(12) Patent Application Publication
(10) Pub. No.: US 2021/0170438 A1
(43) Pub. Date: Jun. 10, 2021

(54) USE OF MODIFIED CELLULOSIC THERMOPLASTIC TO PRODUCE CLEAR CAULK CARTRIDGE

(71) Applicant: Sonoco Development, Inc., Hartsville, SC (US)

(72) Inventor: Subir K. Dey, Florence, SC (US)

(73) Assignee: Sonoco Development, Inc., Hartsville, SC (US)

(21) Appl. No.: 17/110,745

(22) Filed: Dec. 3, 2020

Related U.S. Application Data
(60) Provisional application No. 62/944,070, filed on Dec. 5, 2019.

(51) Int. Cl. B05C 17/005; B05C 17/01; B29C 48/03; B29C 65/06

(52) U.S. Cl. CPC B05C 17/00576; B05C 17/01; B29D 22/003; B29C 65/06; B29C 48/03

(57) ABSTRACT

A caulk cartridge for use with high organic solvent caulk is disclosed. The cartridge includes a cartridge body formed as an open-ended elongate cylindrical tube having a first end, a second end, and an inner surface, a nozzle affixed to the first end of the cartridge body, and a plunger engaging with the inner surface of the cartridge body and forming a seal at the second end and slidable along a longitudinal axis of the cartridge body from the second end toward the first end. The cartridge body is manufactured from a cellulosic thermoplastic with a high organic solvent barrier.

### TECHNICAL FIELD

The present disclosure relates generally to the production of caulk cartridges and more specifically to producing caulk cartridges from modified cellulosic thermoplastic.

### BACKGROUND

Caulk is used widely in a range of buildings to seal joints and seams against leaks. The typical caulk is moisture cured and requires a cartridge which has a high moisture barrier. These cartridges are most commonly made of high-density polyethylene (HDPE).

However, another common variety of caulk sealant contains significant amounts of organic solvents. The standard cartridge materials do not provide a sufficient organic solvent barrier and may dissolve from the contact. Moreover, the high-solvent sealants are generally glass clear. Producers of these solvents prefer clear cartridges for these sealants. Additionally, consumers are increasingly demanding more renewable packaging options.

Therefore, there is a need for a cartridge made from a high-solvent barrier material which is also clear and renewable.

### SUMMARY OF THE DISCLOSURE

In accordance with one aspect of the present disclosure, a caulk cartridge for use with high organic solvent caulk is disclosed. The cartridge includes a cartridge body formed as an open-ended elongate cylindrical tube having a first end, a second end, and an inner surface, a nozzle affixed to the first end of the cartridge body, and a plunger engaging with the inner surface of the cartridge body and forming a seal at the second end and slidable along a longitudinal axis of the cartridge body from the second end toward the first end. The cartridge body is manufactured from a cellulosic thermoplastic with a high organic solvent barrier.

The nozzle and the plunger may additionally be manufactured from the cellulosic thermoplastic.

The cellulosic thermoplastic may have a cellulose content of 30-50 percent.

These and other aspects and features of the present disclosure will be more readily understood after reading the following detailed description in conjunction with the accompanying drawings.

### BRIEF DESCRIPTION OF THE DRAWINGS

FIG. 1 is a caulk cartridge according to the prior art.

FIG. 2 is one embodiment of a caulk cartridge according to the present disclosure.

FIG. 3 is a caulk gun that may be used with the caulk cartridge of FIG. 1 or FIG. 2.

### DETAILED DESCRIPTION

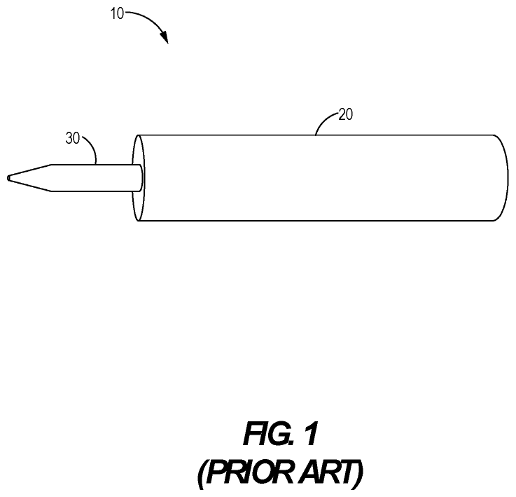

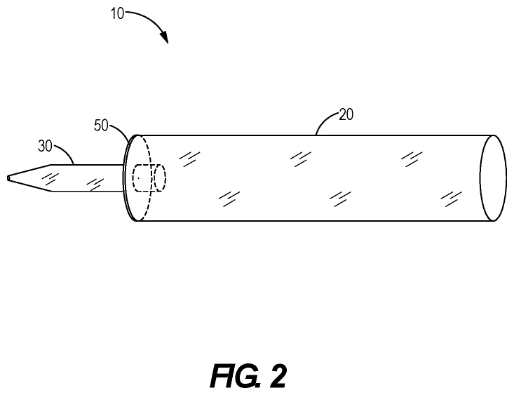

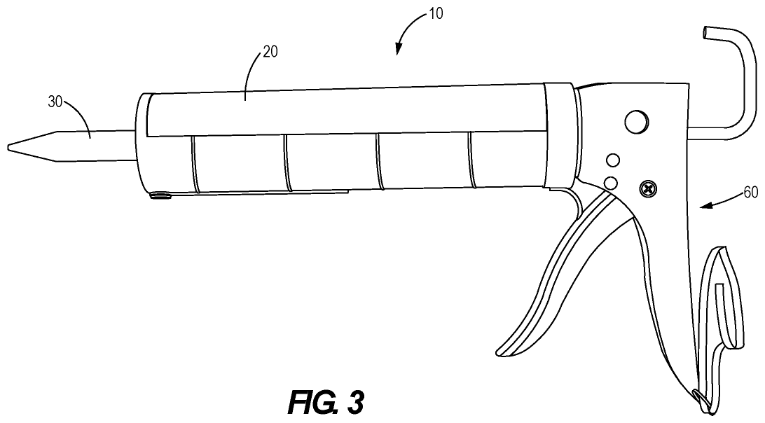

Referring now to the drawings, FIG. 1 depicts an opaque caulk cartridge according to the prior art that would typically be used with a moisture-cured caulk. FIG. 2 depicts a transparent caulk cartridge which may be used with a high-organic-solvent caulk. Structurally, the cartridges of FIG. 1 and FIG. 2 are the same but they are made of different materials as will be discussed. Both cartridges are designed to be used with a standard cartridge gun, as depicted in FIG. 3.

As shown in FIG. 2, the caulk cartridge 10 includes a cartridge body 20 shaped as an open-ended elongate cylindrical tube, a nozzle 30 affixed to a first end of the cartridge body; and a plunger 40 (not shown) at a second end of the cartridge body. The plunger 40 engages with an inner surface of the cartridge body 20 and forms a seal. The first end of the cartridge body 20 may be sealed with a metal foil 50 which prevents the caulk from coming in contact with the nozzle 30 prior to use. This foil 50 may be broken immediately prior to applying caulk to a surface.

The cartridge 10 may further include a label (not shown) indicating brand and properties of the caulk and/or caulk cartridge 10. The label may be printed directly on the cartridge 10 or on a separate layer wrapped around the cartridge body 20.

The caulk cartridge 10, is configured to fit within a standard cartridge gun 60, as shown in FIG. 3 With the application of force by the cartridge gun 60, the plunger 40 slides along a longitudinal axis of the cartridge body 20 from the second end toward the first end. This pushes the caulk out through the nozzle 30.

In order to satisfy combined consumer demands of renewable, clear, and lightweight while simultaneously meeting the necessary high solvent vapor barrier, a new cartridge body material is needed. By chemically modifying cellulose, a biological derived material, a suitable cellulosic thermoplastic can be produced. Cellulosic thermoplastics provide a clear and renewable material with the necessary high organic solvent barrier. The cellulosic thermoplastic may have a cellulose content of 30-50 percent by weight. In one embodiment, the cellulosic thermoplastic may have a cellulose content of 42% by weight. Of course, other percentages of cellulose are possible and in accordance with the present disclosure.

Because of its useful properties, caulk cartridges for use with caulks having a high organic solvent content may be made from cellulosic thermoplastic. Specifically, the cartridge body is made from the cellulosic thermoplastic. The cartridge body 20 may be formed by any suitable process including extrusion or injection molding. In one embodiment, the cellulosic thermoplastic may be extruded at a rate of 75-80 feet per minute. When the cartridge body 20 is made by extrusion, the cartridge body 20 is made separately from the nozzle 30 and may be subsequently joined to the nozzle via spin welding.

In another manufacturing method, the cellulosic thermoplastic may also be used to make the plunger, nozzle, and cartridge body via injection molding. If the cartridge body is made via injection molding, the cartridge body 20 and nozzle 30 may be formed as one piece. Of course, other suitable manufacturing methods may be used.

The nozzle may alternatively be made of any other appropriate polymer material as it does not contact the high organic solvent caulk for extended periods. This includes but is not limited to polyethylene. The plunger may alternatively be made of any other material with a high organic solvent barrier, including but not limited to metal, fluorinated HDPE, or fluorinated polypropylene.

Unlike conventional moisture-cured caulk, caulks made with a significant amount of organic solvents require cartridges made from polymers with a high barrier to organic solvent vapors. Adequate materials can be identified by calculating and comparing the 3-D Hansen solubility parameters. These parameters allow the calculation, through known methods, of a distance parameter and a radius. Using these values, it can be predicted whether a solvent would dissolve a particular polymer. When the distance parameter is greater than the radius, the solvent will not dissolve that polymer. Therefore, that polymer provides a high organic solvent barrier. The cellulosic thermoplastic of the present disclosure provides a high organic solvent barrier for solvents such as benzene, toluene, naphtha, and similar solvents.

What is claimed is:

1. A caulk cartridge for use with high organic solvent caulk, the cartridge comprising:
a cartridge body formed as an open-ended elongate cylindrical tube having a first end, a second end, and an inner surface, the cartridge body being manufactured from a cellulosic thermoplastic having a high organic solvent barrier;
a nozzle affixed to the first end of the cartridge body; and
a plunger engaging with the inner surface of the cartridge body and forming a seal at the second end and slidable along a longitudinal axis of the cartridge body from the second end toward the first end.

2. The caulk cartridge of claim 1, wherein the nozzle is manufactured from the cellulosic thermoplastic.

3. The caulk cartridge of claim 1, wherein the plunger is manufactured from the cellulosic thermoplastic.

4. The caulk cartridge of claim 1, wherein the nozzle and the cartridge body are manufactured in one piece by injection molding.

5. The caulk cartridge of claim 1, wherein the cartridge body is manufactured by extrusion.

6. The caulk cartridge of claim 5, wherein the cartridge body may be extruded at a rate of 75-80 feet per minute.

7. The caulk cartridge of claim 1, wherein the cartridge body and the nozzle are manufactured in two pieces and subsequently joined via spin welding.

8. The caulk cartridge of claim 1, wherein cellulosic thermoplastic has a cellulose content of 30-50% by weight.

9. The caulk cartridge of claim 1, wherein the caulk cartridge is configured to be used with a standard cartridge gun.

10. The caulk cartridge of claim 1, wherein the first end of the cartridge body is sealed with a metal foil.

11. A method of producing a caulk cartridge for use with high organic solvent caulk, comprising:
producing a cartridge body formed as an open-ended elongate cylindrical tube having a first end, a second end, and an inner surface, the cartridge body being manufactured from a cellulosic thermoplastic having a high organic solvent barrier;
producing a nozzle configured to affix to the first end of the cartridge body;
producing a plunger configured to engage with the inner surface of the cartridge body, form a seal at the second end, and slide along a longitudinal axis of the cartridge body from the second end toward the first end.

12. The caulk cartridge of claim 1, wherein the nozzle is manufactured from the cellulosic thermoplastic.

13. The caulk cartridge of claim 1, wherein the plunger is manufactured from the cellulosic thermoplastic.

14. The caulk cartridge of claim 1, wherein the nozzle and the cartridge body are manufactured in one piece by injection molding.

15. The caulk cartridge of claim 1, wherein the cartridge body is manufactured by extrusion.

16. The caulk cartridge of claim 5, wherein the cartridge body may be extruded at a rate of 75-80 feet per minute.

17. The caulk cartridge of claim 1, wherein the cartridge body and the nozzle are manufactured in two pieces and subsequently joined via spin welding.

18. The caulk cartridge of claim 1, wherein cellulosic thermoplastic has a cellulose content of 30-50% by weight.

19. The caulk cartridge of claim 1, wherein the caulk cartridge is configured to be used with a standard cartridge gun.

20. The caulk cartridge of claim 1, wherein the first end of the cartridge body is sealed with a metal foil.
